(19) United States
(12) Patent Application Publication
(10) Pub. No.: US 2007/0116889 A1
(43) Pub. Date: May 24, 2007

(54) Laser treatment of metal

(75) Inventors: Warran B. Lineton, Ann Arbor, MI (US); Jason M. Henderlong, Pinckney, MI (US)

Correspondence Address: DICKINSON WRIGHT PLLC, 38525 WOODWARD AVENUE, SUITE 2000, BLOOMFIELD HILLS, MI, 48304-2970, US

(73) Assignee: Federal Mogul World Wide, Inc.

(21) Appl. No.: 11/282,243

(22) Filed: Nov. 18, 2005

(51) Int. Cl. H05H 1/24; B05D 7/00; B05D 1/28; B29C 71/04

(52) U.S. Cl. 427/569; 427/421.1; 427/429; 427/532

(57) ABSTRACT

The invention provides a method for processing a ferrous work-piece. The method includes the step of coating a surface of a ferrous work-piece with a predetermined material. The method also includes the step of generating a plasma at the surface with a laser by at least partially vaporizing the predetermined material to release electrons and ions. Different materials can be selected as the coating material to promote different surface changes. For example, carbon can be selected as the coating material for improved hardness. Phosphate can be selected as the coating material for enhanced tribological properties.

### BACKGROUND OF THE INVENTION

1. Field of the Invention

The invention relates to a process for changing a property of a ferrous work-piece and more particularly to subjecting a ferrous work-piece to a laser to change a surface condition of the metal work-piece.

2. Description of Related Art

Lasers can rapidly heat a surface of a work-piece for adjusting properties of the surface. An absorptive coating can be applied to the surface to be heated to enhance the energy transfer from the laser to the work-piece. By using a laser to quickly heat a surface, conventional quenching by a gas or a liquid is unnecessary since only the shallow surface area is heated. The part will actually self-quench, due to the extremely high heat differential between the surface layer heated by the laser and the remainder of the work-piece. This is in sharp contrast to carburizing or induction heating, where the part must be heated in one operation, and then is required to be quickly quenched by a gas or a liquid. Laser radiation can be generated by CO₂, Excimer or Nd-YAG lasers, which can achieve intensities of more than 10⁶ watt/cm². A sample work-piece 10 treated with laser radiation according to the prior art is shown in FIG. 1. The depth 12 of treatment is approximately 2 microns.

### SUMMARY OF THE INVENTION

The invention provides a method for processing a ferrous work-piece. The method includes the step of coating a surface of a ferrous work-piece with a predetermined material. The method also includes the step of generating a plasma at the surface with a laser by at least partially vaporizing the predetermined material to release electrons and ions. Different materials can be selected as the coating material to promote different surface changes. For example, carbon can be selected as the coating material for improved hardness. A metal phosphate can be selected as the coating material for enhanced tribological properties.

### BRIEF DESCRIPTION OF THE DRAWINGS

Advantages of the present invention will become more readily appreciated when considered in connection with the following detailed description and appended drawings, wherein:

FIG. 1 is a cross-section a work-piece after laser treatment according to the prior art;

FIG. 2 is a simplified flow chart illustrating the steps for performing the exemplary embodiment of the invention;

FIG. 3 is a cross-section a work-piece prior to laser treatment according to the exemplary embodiment of the invention;

FIG. 4 is a cross-section a work-piece after laser treatment according to the exemplary embodiment of the invention;

FIG. 5 is a first photograph of a reaction occurring during the exemplary embodiment of the invention along a short axis of a laser wherein an initiating flame is shown above the surface of the work-piece;

FIG. 6 is a second photograph of the reaction taken along the long axis of the laser and occurring just after flame initiation wherein the reaction is changing to a plasma;

FIG. 7 is a third photograph of the reaction taken along the long axis of the laser and occurring after a stable plasma has been generated; and

FIG. 8 is a fourth photograph of the reaction taken along the short axis of the laser and occurring after a stable plasma has been generated.

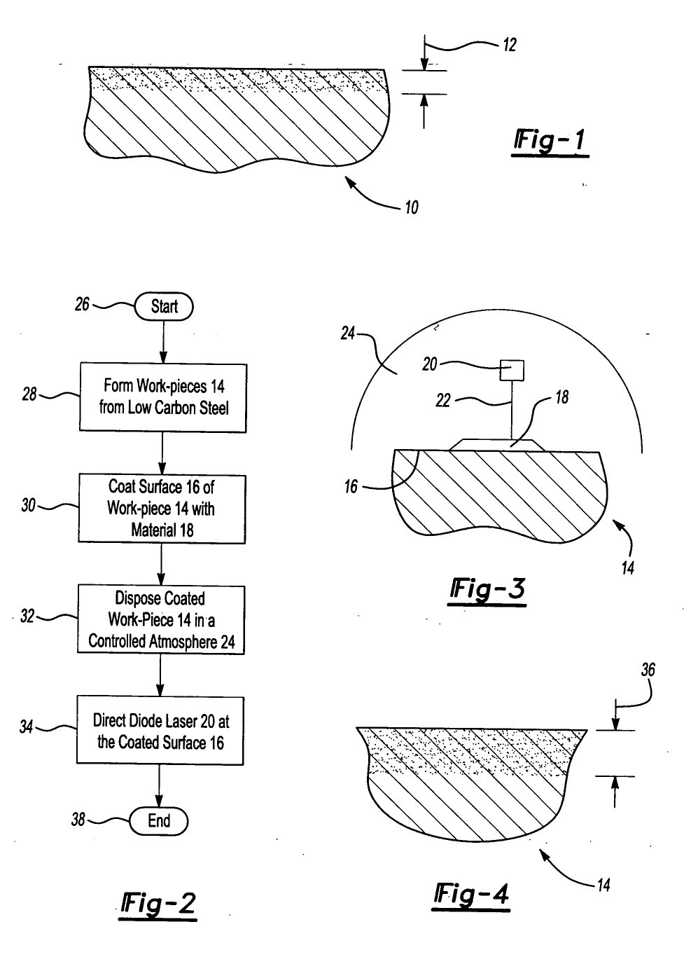

### DETAILED DESCRIPTION OF THE PREFERRED EMBODIMENT

A process according to a first exemplary embodiment of the invention is shown in FIG. 2. The process starts at step 26. At step 28, a work piece 14, shown in FIGS. 3 and 4, is formed from low carbon steel. Typically, low carbon steel is steel having about 0.1% carbon or less. The exemplary work piece 14 can be formed from 1010 steel. Prior to step 28, the process could also include the step of applying an initial surface finish to the work-piece, such as by machining, grinding to a given grit size, or polished to a given diamond finish.

The process continues to step 30 and a surface 16 of the work piece 14 is coated with a material 18. Different coatings can be applied to the surface 16 to achieve different desired results. For example, in a first exemplary embodiment of the invention, the material 18 can be carbon for improving the hardness and wear resistance of the work piece 14. The carbon can be applied in the form of hairspray sprayed on the surface 16. In another embodiment, electrodag can be applied to the surface 16. Electrodag can be acquired from Acheson Colloids in Port Huron, Mich. The carbon can be applied to a depth of five microns. Alternatively, carbon can be applied to the surface 16 such that 0.9 milligrams of carbon are disposed per square centimeter of the surface 16. In another embodiment in the invention, one to two microns of carbon can be disposed on the surface 16 by vacuum deposit.

The use of carbon for the coating material 18 can result in improved hardness and wear resistance in the work-piece 14. In alternative embodiments of the invention, the material 18 can be selected to result in different material property changes at the surface 16. For example, the material 18 can be a phosphate to enhance the surface lubrication of the work piece 14. Generally, the phosphate can be applied to the surface 16 in greater quantities than the quantities set forth above with respect to carbon.

After step 30, the process continues to step 32 and the coated work piece 14 is disposed in a controlled atmosphere 24, best shown in FIG. 3. The controlled atmosphere can be air or nitrogen or a combination of air and nitrogen. Other possible gasses for use in the controlled atmosphere 24 include methane and argon. Nitrogen can be used if a nitride surface is desired. Also, oxygen should be excluded from the atmosphere 24 if a nitride surface is desired. The controlled atmosphere 24 is maintained at a pressure slightly higher than atmospheric in the exemplary process.

The process continues to step 34 and the diode laser 20 is directed at the coated surface 16. The exemplary laser 20 is a 4 kilowatt diode laser and emits a beam 22 at the material 18. As a result of the application of energy by the laser 20, the surface 16 and the material 18 form a chemical mixture containing reactive species. It has been observed that a plasma is created at the surface 16 fed by the energy from the chemical reactions between the material 18 and the surface 16 as well as the energy provided by the laser 20. As a result, after the application of the laser 20 to the surface 16, the work piece 14 has been treated to a depth 36. The depth can be between five microns and 20 microns. The depth 36 can be substantially greater than the depth 12 produced by prior art laser treatments. The process ends at step 38.

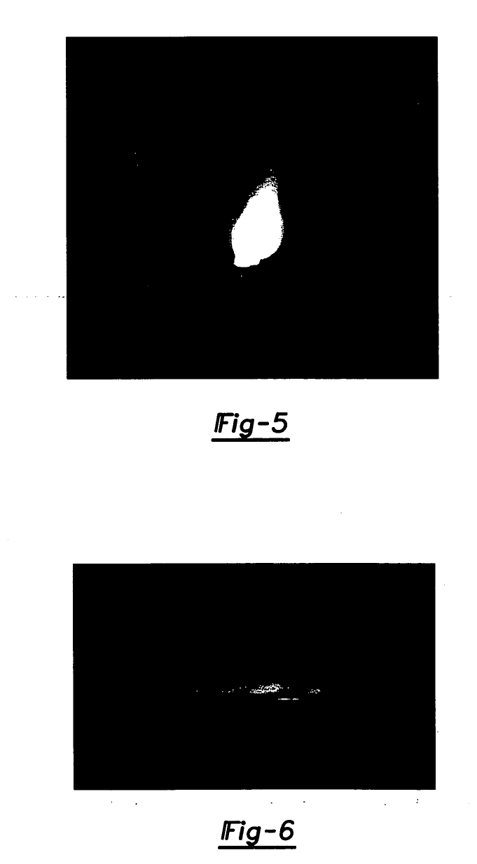

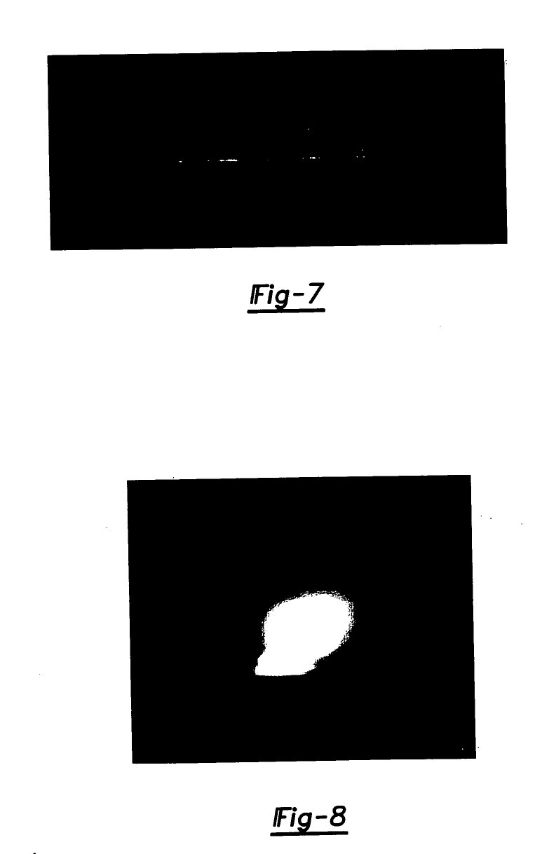

FIGS. 5-8 are photographs that illustrate conditions at the surface 16 of the work-piece 14 during the exemplary method. Graphs have been applied to provide perspective. In FIG. 5, a flame is generated when the laser 20 is first applied to the surface 16. It is believed that the flame occurs as a result the vaporization of carbon in the material 18. FIG. 6 shows that the flame diminishes and FIGS. 7 and 8 shows the flame replaced with a bright, well controlled zone of plasma. The zone cannot be safely observed by the naked eye. It has also been observed that a popping noise occurs initially during the process; the popping being evidence that some reaction other than the flame is occurring at the surface 16.

Generally, it is believed that an energy level above 10⁶ watts/cm² is required to generate plasma in air. However, it is known that the presence of vaporized metal or water can reduce the energy required to generate plasma since free electrons and/or ions are contained with the vaporized metal/water. It is believed that the carbon material 18 is vaporized during initial application of the laser 20 and that the vaporized carbon facilitates the creation of plasma.

The above-described first exemplary process according to the invention can be used to harden particular surfaces of work-pieces such as pistons and pistons rings, or any other work-piece formed from low carbon steel. In a second exemplary embodiment of the invention, a work-piece having a relatively higher quantity of carbon can be hardened. For example, a cast iron work-piece, such as a brake rotor, can be hardened.

The process for hardening the cast iron work-piece can be similar to the process for hardening the low-carbon steel work-piece. Preferably, the cast iron work-piece is placed in a controlled environment and subjected to a 4 kilowatt diode laser. A relatively thin layer of coating material is placed on the surface of the cast iron work-piece. In one example, a black marker was used to color the surface to be treated with black ink. The ink of the marker is absorptive of the wavelength of the laser. The surface of the cast iron work-piece is positioned at the focus of the beam emitted by the diode laser. Preferably, the laser is moved along the surface at a scan speed of 3.5 meters/minute. The laser will vaporize the chemicals in the ink, including the carbon, and generate a plasma. The scan speed will prevent the work-piece from absorbing an undesirable amount of energy and overheat. Also, the scan speed substantially eliminates the need to preheat the work-piece to avoid cracking at the surface. A thin layer of the cast iron work-piece is melted, about 50-100 microns. The excess graphite in the cast iron is converted to a hard carbide structure, resulting in surface with enhanced hardness and wear resistance.

As set forth more fully above, the invention can be used with work-pieces having relatively higher quantities of carbon, such as cast iron, to improve hardness as well as with work-pieces having relatively lower quantities of carbon, such as 1010 steel, to improve hardness. In the case of a cast iron work-piece, the carbon coating acts like a “plasma propellant” to promote the conversion of contained graphite to hard carbide. In the case of a low carbon steel work-piece, the carbon coating acts like a plasma propellant and combines with the steel to improve hardness.

Obviously, many modifications and variations of the present invention are possible in light of the above teachings. It is, therefore, to be understood that within the scope of the appended claims, the invention may be practiced otherwise than as specifically described.

What is claimed is:

1. A method for processing a ferrous work-piece comprising the steps of:
coating a surface of a ferrous work-piece with a predetermined material; and
generating a plasma at the surface with a laser by at least partially vaporizing the predetermined material to release electrons and ions.

2. The method of claim 1 wherein said generating step includes the step of:
changing at least one material property of the ferrous work-piece to a depth of at least five microns.

3. The method of claim 2 wherein said changing step is further defined as:
changing at least one material property of the ferrous work-piece to a depth of at least ten microns.

4. The method of claim 3 wherein said changing step is further defined as:
changing at least one material property of the ferrous work-piece to a depth of at least twenty microns.

5. The method of claim 4 wherein said changing step is further defined as:
changing at least one material property of the ferrous work-piece to a depth of at least fifty microns.

6. The method of claim 1 further comprising the step of:
selecting low-carbon steel to form the ferrous work-piece.

7. The method of claim 1 further comprising the step of:
selecting cast iron to form the ferrous work-piece.

8. The method of claim 1 wherein said coating step is further defined as:
coating the surface of the ferrous work-piece with carbon.

9. The method of claim 8 wherein said coating step is further defined as:
spraying hairspray on the ferrous work-piece.

10. The method of claim 8 wherein said coating step is further defined as:
applying electrodag to the surface of the ferrous work-piece.

11. The method of claim 8 wherein said coating step is further defined as:
applying carbon to the surface of the ferrous work-piece at least one micron deep by vacuum deposit.

12. The method of claim 8 wherein said coating step is further defined as:
applying ink having carbon to the surface with a marker wherein said ink is absorptive at laser wavelength.

13. The method of claim 8 wherein said coating step is further defined as:
coating the surface of the ferrous work-piece with carbon applied to a depth of one micron.

14. The method of claim 8 wherein said coating step is further defined as:
coating the surface of the ferrous work-piece with carbon applied to a depth of five microns.

15. The method of claim 8 wherein said coating step is further defined as:
coating of the surface of the ferrous work-piece with 0.9 milligrams of carbon per square centimeter of the surface.

16. The method of claim 8 further comprising the step of:
selecting low-carbon steel to form the ferrous work-piece, wherein said generating step includes the step of increasing a hardness of the low-carbon steel work-piece to a depth of at least ten microns.

17. The method of claim 1 further comprising the step of:
disposing the ferrous work-piece in a controlled atmosphere of one of air and nitrogen and argon.

18. The method of claim 17 further comprising the step of:
selecting low-carbon steel to form the ferrous work-piece.

19. The method of claim 18 wherein said coating step is further defined as:
applying electrodag to the surface of the low-carbon steel, ferrous work-piece to a depth of at least five microns.

20. The method of claim 19 wherein said generating step includes the step of:
directing a diode laser at the surface.

21. The method of claim 20 wherein said generating step includes the step of:
increasing a hardness of the surface of the low-carbon steel work-piece by increasing the carbon content of the low-carbon steel work-piece to a depth of substantially twenty microns.

22. The method of claim 17 further comprising the step of:
selecting cast iron to form the ferrous work-piece.

23. The method of claim 22 wherein said coating step is further defined as:
applying carbon to the surface of the cast iron, ferrous work-piece to a depth of substantially one micron.

24. The method of claim 23 wherein said generating step includes the step of:
directing a diode laser at the surface.

25. The method of claim 24 wherein said generating step includes the step of:
increasing a hardness of the surface of the cast iron, ferrous work-piece by melting the cast iron, ferrous work-piece to a depth of substantially fifty microns to form iron carbides from graphite in the cast iron, ferrous work-piece.

26. The method of claim 25 wherein said directing step further comprises the steps of:
emitting a four kilowatt diode laser at the surface;
positioning the surface at a focus point of a laser beam of the four kilowatt diode laser; and
scanning the four kilowatt diode laser across the surface at a speed of three and one-half meters per minute.

27. The method of claim 5 wherein said coating step is further defined as:
coating the surface of the ferrous work-piece with phosphate.

28. A method for processing a ferrous work-piece comprising the steps of:
coating a surface of a ferrous work-piece with a predetermined material;
disposing the ferrous work-piece in a controlled atmosphere;
generating a plasma at the surface with a diode laser by at least partially vaporizing the predetermined material to release electrons and ions, wherein a material property of the ferrous work-piece changes to a depth of at least five microns from the surface after said generating step.
